(19) United States
(12) Patent Application Publication
(10) Pub. No.: US 2026/0170843 A1
(43) Pub. Date: Jun. 18, 2026

(54) METHOD AND DEVICE FOR LEARNING KNOWLEDGE DISTILLATION BASED ON MULTI-SENSOR, METHOD AND DEVICE FOR INFERRING IMAGE BEV FEATURE INFORMATION, AND COMPUTER-READABLE STORAGE MEDIUM STORING INSTRUCTIONS FOR PERFORMING METHOD FOR LEARNING KNOWLEDGE DISTILLATION BASED ON MULTI-SENSOR

(71) Applicants: Hyundai Motor Company, Seoul (KR); Kia Corporation, Seoul (KR)

(72) Inventors: Da Ye OH, Hwaseong-Si (KR); Jun Hyung KIM, Hwaseong-Si (KR); Jun Ho KOH, Hwaseong-Si (KR)

(21) Appl. No.: 19/421,522

(22) Filed: Dec. 16, 2025

(30) Foreign Application Priority Data
Dec. 17, 2024 (KR) 10-2024-0188826

(51) Int. Cl. G06V 20/56; B60W 60/00; G01S 13/86; G01S 13/931; G01S 17/86; G01S 17/89; G01S 17/931

(52) U.S. Cl. CPC G06V 20/56; B60W 60/001; G01S 13/862; G01S 13/865; G01S 13/867; G01S 13/931; G01S 17/86; G01S 17/89; G01S 17/931

(57) ABSTRACT

There is provided a multi-sensor-based knowledge distillation learning method. The method comprises determining a sensor data received from a plurality of sensors, and generating at least one piece of sensor data-based voxel feature information using the sensor data; performing view transformation on the at least one piece of sensor data-based voxel feature, and generating a first voxel BEV feature information using the view-transformed feature information; generating a second voxel BEV feature information using the at least one piece of sensor data-based voxel feature information; generating the first voxel BEV feature information and the second voxel BEV feature information to construct fused voxel BEV feature information; performing learning of an image view transformation model; and performing learning of an image BEV generation model that generates image BEV feature information corresponding to the view-transformed image feature information by using the fused voxel BEV feature information.

### CROSS-REFERENCE TO RELATED APPLICATION

This application claims the benefit of priority to Korean Patent Application No. 10-2024-0188826, filed in the Korean Intellectual Property Office on Dec. 17, 2024, the disclosure of which is incorporated herein by reference in its entirety.

### TECHNICAL FIELD

The disclosed disclosure relates to a vehicle and a control method therefor, and more specifically, to a sensor fusion technology.

### BACKGROUND

The matters described in this Background section are only for enhancement of understanding of the background of the disclosure, and should not be taken as acknowledgment that they correspond to prior art already known to those skilled in the art.

An autonomous vehicle may recognize a road environment by itself, determine a driving situation, and move from a current position to a target position along a planned driving path.

In this case, the autonomous vehicle may use a sensor fusion device, and the sensor fusion device may allow other vehicles, obstacles, and roads to be recognized through a combination of various sensors such as a camera, radar, and lidar.

To this end, signals or data detected through various sensors should be fused, but since detection distances and characteristics of recognized data are different depending on types of sensors, various attempts are being performed to fuse signals or data detected through the sensors.

### SUMMARY

The disclosed disclosure is directed to providing a knowledge distillation method and device in which data detected from an ultrasonic sensor, a radar sensor, a lidar sensor, etc., is utilized for learning of a camera object recognition network.

Technical problems to be solved in the present disclosure are not limited to the technical problems, which have been mentioned above, and other technical problems that are not mentioned will be clearly understood by those of ordinary skill in the art to which the present disclosure belongs from the following description.

According to the present disclosure, a method performed by an apparatus for a vehicle may comprise obtaining, via a plurality of sensors of the vehicle, sensor data, generating, based on the sensor data, at least one piece of sensor data-based voxel feature information, performing a view transformation on the at least one piece of sensor data-based voxel feature information to construct sensor data-based view-transformed feature information, generating, based on the sensor data-based view-transformed feature information, first voxel bird's-eye-view (BEV) feature information, generating, based on the at least one piece of sensor data-based voxel feature information, second voxel BEV feature information, generating, based on the first voxel BEV feature information and the second voxel BEV feature information, fused voxel BEV feature information, determining, based on image data obtained via a camera of the vehicle, image feature information, training, based on the sensor data-based view-transformed feature information and the image feature information, an image view transformation model trained to perform view transformation on the image feature information to generate view-transformed image feature information, training, based on the fused voxel BEV feature information, an image BEV generation model trained to generate image BEV feature information corresponding to the view-transformed image feature information, transmitting, to the vehicle, a signal indicating the image BEV feature information, and causing, based on the transmitting of the signal, a control operation of the vehicle (e.g., process and display an object image, control autonomous driving (e.g., steering wheel control, speed control, MRM, etc.), generate a notification (visual, audible, tactile) indicating the object in a BEV image).

The method may comprise performing the view transformation using a view transformation model, wherein the view transformation model is a model trained to perform the view transformation based on a coordinate system in which the image feature information is view-transformed. The generating of the at least one piece of sensor data-based voxel feature information may comprise inputting the sensor data to a backbone network that outputs voxel feature information and, based on the voxel feature information output from the backbone network, generating the at least one piece of sensor data-based voxel feature information.

The method may further comprise generating, based on a teacher model and based on the sensor data, the at least one piece of sensor data-based voxel feature information, the sensor data-based view-transformed feature information, the first voxel BEV feature information, the second voxel BEV feature information, and the fused voxel BEV feature information, wherein the fused voxel BEV feature information is constructed by concatenating the first voxel BEV feature information and the second voxel BEV feature information. The method may further comprise inputting the image feature information to the trained image view transformation model and outputting the view-transformed image feature information from the trained image view transformation model, and inputting the view-transformed image feature information to the trained image BEV generation model and outputting the image BEV feature information from the trained image BEV generation model.

The generating of the at least one piece of sensor data-based voxel feature information may be based on a part of the sensor data, wherein the part is obtained via at least one of a light detection and ranging sensor of the vehicle, a radar sensor of the vehicle, or an ultrasonic sensor of the vehicle. The training of the image BEV generation model may comprise adjusting parameters of the image BEV generation model to cause the image BEV feature information to match the fused voxel BEV feature information.

According to the present disclosure, an apparatus for a vehicle may comprise a plurality of sensors comprising at least one of a camera, a light detection and ranging sensor, a radar sensor, or an ultrasonic sensor, a processor, and a memory storing at least one instruction that, when executed by the processor, is configured to cause the apparatus to obtain, via the plurality of sensors, sensor data, generate, based on the sensor data, at least one piece of sensor data-based voxel feature information, perform a view transformation on the at least one piece of sensor data-based voxel feature information to construct sensor data-based view-transformed feature information, generate, based on the sensor data-based view-transformed feature information, first voxel BEV feature information, generate, based on the at least one piece of sensor data-based voxel feature information, second voxel BEV feature information, generate, based on the first voxel BEV feature information and the second voxel BEV feature information, fused voxel BEV feature information, determine, based on image data obtained via the camera, image feature information, train, based on the sensor data-based view-transformed feature information and the image feature information, an image view transformation model trained to perform a view transformation on the image feature information to generate view-transformed image feature information, train, based on the fused voxel BEV feature information, an image BEV generation model trained to generate image BEV feature information corresponding to the view-transformed image feature information, transmit, to the vehicle, a signal indicating the image BEV feature information, and cause, based on the transmission of the signal, a control operation of the vehicle.

The at least one instruction, when executed by the processor, may be configured to cause the apparatus to use a view transformation model to perform the view transformation on the at least one piece of sensor data-based voxel feature information, wherein the view transformation model is a model trained to perform the view transformation based on a coordinate system in which the image feature information is view-transformed. The at least one instruction, when executed by the processor, may be configured to cause the apparatus to input the sensor data to a backbone network that outputs voxel feature information and, based on the voxel feature information output from the backbone network, generate the at least one piece of sensor data-based voxel feature information. The at least one instruction, when executed by the processor, may be configured to cause the apparatus to generate, based on a teacher model and based on the sensor data, the at least one piece of sensor data-based voxel feature information, the sensor data-based view-transformed feature information, the first voxel BEV feature information, the second voxel BEV feature information, and the fused voxel BEV feature information, wherein the fused voxel BEV feature information is constructed by concatenating the first voxel BEV feature information and the second voxel BEV feature information.

The at least one instruction, when executed by the processor, may be configured to cause the apparatus to input the image feature information to the trained image view transformation model and output the view-transformed image feature information from the trained image view transformation model, and input the view-transformed image feature information to the trained image BEV generation model and output the image BEV feature information from the trained image BEV generation model. The at least one instruction, when executed by the processor, may be configured to cause the apparatus to generate the at least one piece of sensor data-based voxel feature information based on a part of the sensor data, wherein the part is obtained via at least one of the light detection and ranging sensor, the radar sensor, or the ultrasonic sensor. The at least one instruction, when executed by the processor, may be configured to cause the apparatus to train the image BEV generation model by adjusting parameters of the image BEV generation model to cause the image BEV feature information to match the fused voxel BEV feature information.

According to the present disclosure, a non-transitory computer-readable medium may store instructions that, when executed, cause an apparatus for a vehicle to obtain, via a plurality of sensors of the vehicle, sensor data, generate, based on the sensor data, at least one piece of sensor data-based voxel feature information, perform a view transformation on the at least one piece of sensor data-based voxel feature information to construct sensor data-based view-transformed feature information, generate, based on the sensor data-based view-transformed feature information, first voxel BEV feature information, generate, based on the at least one piece of sensor data-based voxel feature information, second voxel BEV feature information, generate, based on the first voxel BEV feature information and the second voxel BEV feature information, fused voxel BEV feature information, determine, based on image data obtained via a camera of the vehicle, image feature information, train, based on the fused voxel BEV feature information and image feature information, an image view transformation model trained to perform view transformation on the image feature information to generate view-transformed image feature information, train, based on the fused voxel BEV feature information, an image BEV generation model trained to generate image BEV feature information corresponding to the view-transformed image feature information, transmit, to the vehicle, a signal indicating the image BEV feature information, and cause, based on the transmission of the signal, autonomous driving control of the vehicle.

The instructions, when executed, may further cause the apparatus to perform the view transformation by using a view transformation model, wherein the view transformation model is a model trained to perform the view transformation based on a coordinate system in which the image feature information is view-transformed. The instructions, when executed, may further cause the apparatus to input the sensor data to a backbone network that outputs voxel feature information and, based on the voxel feature information output from the backbone network, generate the at least one piece of sensor data-based voxel feature information.

The instructions, when executed, may further cause the apparatus to generate, based on a teacher model and based on the sensor data, the at least one piece of sensor data-based voxel feature information, the sensor data-based view-transformed feature information, the first voxel BEV feature information, the second voxel BEV feature information, and the fused voxel BEV feature information, wherein the fused voxel BEV feature information is constructed by concatenating the first voxel BEV feature information and the second voxel BEV feature information. The instructions, when executed, may further cause the apparatus to input the image feature information to the trained image view transformation model and output the view-transformed image feature information from the trained image view transformation model, and input the view-transformed image feature information to the trained image BEV generation model and output the image BEV feature information from the trained image BEV generation model. The instructions, when executed, may further cause the apparatus to generate, based on a part of the sensor data, the at least one piece of sensor data-based voxel feature information, wherein the part is obtained via at least one of a light detection and ranging sensor of the vehicle, a radar sensor of the vehicle, or an ultrasonic sensor of the vehicle.

The advantages and effects attainable through the present disclosure are not limited to those expressly recited above. Additional advantages and effects, which have not been explicitly mentioned, will be apparent to, and readily appreciated by, those of ordinary skill in the art to which the present disclosure pertains from the following description.

### BRIEF DESCRIPTION OF THE DRAWINGS

The above and other objects, features and advantages of the present disclosure will become more apparent to those of ordinary skill in the art by describing exemplary examples thereof in detail with reference to the accompanying drawings, in which:

FIG. 1 shows an example that a vehicle transmits and receives data by communicating with another device;

FIG. 2 shows exemplary modules constituting a vehicle;

FIG. 3 shows an example of a detailed configuration of a processor and a memory for autonomous driving control in an autonomous driving device;

FIG. 4 shows exemplary components that process multi-sensor-based knowledge distillation;

FIG. 5 shows exemplary characteristics of a view-transformed voxel feature information and a fused BEV feature information used in FIG. 4;

FIG. 6 shows an exemplary operation of the multi-sensor-based knowledge distillation method; and

FIG. 7 shows an example computing system.

### DETAILED DESCRIPTION

The advantages and features of the examples and the methods of accomplishing the examples will be clearly understood from the following description taken in conjunction with the accompanying drawings. However, examples are not limited to those examples described, as examples may be implemented in various forms. It should be noted that the present examples are provided to make a full disclosure and also to allow those skilled in the art to know the full range of the examples. Therefore, the examples are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of modern technologies, and the like. In addition, in certain cases, there are terms arbitrarily selected by the applicant, and in this case, the meaning of the terms will be described in detail in the description of the corresponding disclosure. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module,” “unit” or “portion” used in the specification means a software and/or hardware component, and the “module,” “unit” or “portion” performs certain operations/functions/roles. However, the “module,” “unit” or “portion” is not construed as being limited to software or hardware. The “module,” “unit” or “portion” may be configured to be in an addressable storage medium or to execute one or more processors. Therefore, as an example, the “module,” “unit” or “portion” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “module,” “unit” or “portion” may be combined into a smaller number of components, “modules”, “units” or “portions” or further divided into additional components, “modules”, “units” or “portions”.

In the present disclosure, the “module,” “unit” or “portion” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control settings (e.g., an autonomous driving classification or a selected autonomous driving level). Based on a feature of a sensor-fused BEV model guiding an image BEV model, an operation of the vehicle may be controlled. For example, when the fused voxel BEV feature information identifies an obstacle or road-edge deviation that the image BEV feature information underestimates, the processor may adjust braking control, steering control, or acceleration change-rate control to maintain safe autonomous operation. In another example, when the modality gap between the fused voxel BEV feature information and the image BEV feature information exceeds a threshold, the processor may tighten alarm timing control or forward-collision-warning timing to increase driver preparedness.

One or more auxiliary devices (e.g., an engine brake, exhaust brake, hydraulic retarder, electric retarder, regenerative brake, etc.) may also be controlled based on a feature of a sensor-fused BEV model guiding an image BEV model. For example, when the fused voxel BEV feature information detects a downhill obstacle or reduced-friction surface that the image BEV model underestimates, the processor may increase regenerative braking to stabilize the vehicle. In another example, when the modality gap between the fused voxel BEV feature information and the image BEV feature information exceeds a threshold in the presence of a nearby stopped vehicle, the processor may activate an engine brake or retarder earlier to safely reduce speed.

One or more communication devices (e.g., a modem, a network adapter, a radio transceiver, an antenna, etc., capable of communicating via Ethernet, Wi-Fi, NFC, Bluetooth, LTE, 5G NR, or V2X) may also be controlled based on a feature of a sensor-fused BEV model guiding an image BEV model. For example, when the fused voxel BEV feature information reveals a sudden hazard or low-visibility condition that the image BEV model underestimates, a processor may increase the frequency of V2X safety broadcasts to nearby vehicles or request roadside-unit assistance. In another example, when the modality gap between the fused voxel BEV feature information and the image BEV feature information exceeds a threshold, the processor may automatically trigger a high-reliability communication mode (e.g., switching from Wi-Fi to LTE/5G NR) to obtain external perception data or high-precision map updates. Minimum risk maneuver (MRM) operations may also be controlled, for example, based on a feature of a sensor-fused BEV model guiding an image BEV model. For instance, when the fused voxel BEV feature information detects an obstacle or road-edge condition that the image BEV feature information fails to capture due to low visibility, and the modality gap between the two exceeds a threshold, the processor may initiate an MRM by slowing the vehicle and steering it toward a safe stop area. In another example, when the fused voxel BEV feature information indicates a sudden hazard in the vehicle's path (e.g., a stalled vehicle or debris) while the image BEV model shows degraded reliability, the processor may activate an MRM sequence that includes controlled deceleration, lane-keeping bias, and stopping the vehicle within a predefined safe zone.

Biased driving operation(s) may also be controlled, for example, based on a feature of a sensor-fused BEV model guiding an image BEV model. For instance, when the fused voxel BEV feature information detects an object or lane-edge offset that the image BEV feature information underestimates due to low visibility (e.g., glare, rain, or shadows), the processor may bias the vehicle laterally within the lane to maintain a safer gap from the detected object. In another example, when the modality gap between the fused voxel BEV feature information and the image BEV feature information increases near adjacent vehicles, the driving control apparatus may temporarily shift the biased target lateral distance toward the lane center to stabilize the vehicle's path during lane changes or curved-road driving.

One or more sensors (e.g., IMU sensors, camera, LIDAR, RADAR, blind-spot monitoring sensor, line-departure warning sensor, parking sensor, light sensor, rain sensor, traction-control sensor, anti-lock braking system sensor, tire-pressure monitoring sensor, seatbelt sensor, airbag sensor, fuel sensor, emission sensor, throttle-position sensor, inverter, converter, motor controller, power-distribution unit, high-voltage wiring and connectors, auxiliary power modules, charging interface, etc.) may also be controlled, for example, based on a feature of a sensor-fused BEV model guiding an image BEV model. For instance, when the fused voxel BEV feature information indicates an obstacle in a region where the image BEV model shows low confidence, the processor may increase sampling rates of specific sensors (e.g., LIDAR or radar) or activate dormant sensors (e.g., ultrasonic sensors) to reinforce perception. In another example, when the modality gap between the fused voxel BEV feature information and the image BEV feature information exceeds a threshold, the processor may adjust sensor operating parameters (e.g., camera exposure, radar gain, or LIDAR pulse rate) to improve perception consistency.

According to the present disclosure, an autonomous driving level and/or autonomous driving activation or deactivation may also be controlled based on a feature of a sensor-fused BEV model guiding an image BEV model. For example, when the fused voxel BEV feature information generated from lidar, radar, and ultrasonic sensors (e.g., high-confidence BEV object positions or depth cues) significantly deviates from the image BEV feature information output by the camera-based model, the processor may determine that the image-only perception reliability is reduced and lower the autonomous driving level (e.g., from Level 4 to Level 2) or temporarily deactivate autonomous driving. In another example, when the modality gap between the sensor-fused BEV feature information and the image BEV feature information exceeds a threshold, the vehicle may require increased driver attentiveness (e.g., requiring hands-on-wheel more frequently or requiring the driver to look ahead within a shorter time interval) or may restrict certain convenience features (e.g., disabling video display on the vehicle screen) until the perception confidence recovers.

According to the present disclosure, camera-based object recognition may be enhanced by leveraging complementary characteristics of heterogeneous sensors such as ultrasonic sensors, radar sensors, and lidar sensors. Sensor data obtained from these devices is converted into structured feature information, including voxel-based and bird's-eye-view (BEV) feature representations, which serve as reliable supervisory signals for training an image-based recognition network. Through a knowledge-distillation process, fused multi-sensor BEV feature information is used to guide learning of an image view-transformation model and an image BEV-generation model, enabling a camera network to approximate the perception quality achievable through multi-sensor fusion. As a result, a camera-based recognition system may be trained in real time and with improved accuracy, even when only image data is available during deployment.

Hereinafter, the example of the present disclosure will be described in detail with reference to the accompanying drawings so that those of ordinary skill in the art may easily implement the present disclosure. In the drawings, portions not related to the description are omitted in order to clearly describe the present disclosure.

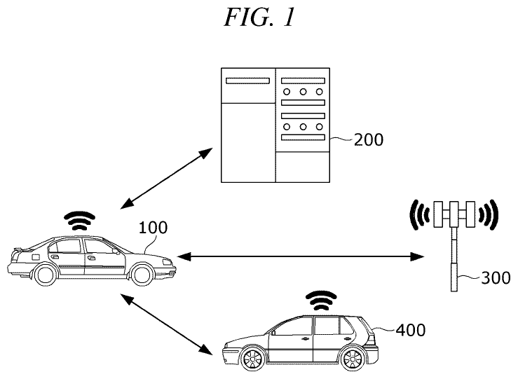

FIG. 1 shows an example that a vehicle transmits and receives data by communicating with another device.

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen (e.g., compressed hydrogen, liquefied hydrogen, or hydrogen-rich reformate gas, etc.), but various other gases may also be applicable. In the case of fossil energy, the vehicle 100 may be driven based on fuels such as gasoline, diesel, or liquefied gas (e.g., propane, butane, or natural gas, etc.), and it may be equipped with an internal combustion engine that drives an actuator 116 by burning the fuel. The engine may be included in an energy generator 110 in terms of providing rotational driving force to the wheel driver 118. As another example, the vehicle 100 may be a hybrid type vehicle selectively utilizing the energy of a fossil fuel-based internal combustion engine and an electric battery to drive the actuating unit 116 (e.g., in parallel-hybrid, mild-hybrid, or plug-in hybrid configurations, etc.).

The vehicle 100 may refer to a movable device. The vehicle 100 may be a ground vehicle, such as a typical passenger or commercial vehicle, or a purpose-built vehicle (PBV) for specific purposes. The vehicle 100 may be a four-wheeled vehicle, such as a passenger car, SUV, or small truck, or a vehicle with more than four wheels, such as a bus, large truck, container carrier, or heavy equipment (e.g., excavators, forklifts, or mining haulers, etc.). The vehicle 100 may also be a robot in the broad sense of a movable means, and the robot may move using wheels, tracks, or other mobility modules (e.g., articulated tracks, omni-wheels, or robotic legs, etc.).

The vehicle 100 may be controlled and driven autonomously, and autonomous driving may be implemented as semi-autonomous driving or fully autonomous driving. Fully autonomous driving may be provided as autonomous movement in which the processor 122 of the vehicle 100 fully controls the driving without user intervention, even in uncertain driving conditions (e.g., low-visibility weather, complex intersections, or congested urban roads, etc.). Semi-autonomous driving may be provided as autonomous movement that requires driver intervention in specific driving situations. Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5.

Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices (e.g., smartphones, tablets, or wearable devices, etc.). The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100 (e.g., map updates, software patches, or real-time traffic information, etc.).

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100 (e.g., providing signal-phase timing, work-zone alerts, or pedestrian-crossing warnings, etc.). The vehicle 100 may support manual or autonomous driving by exchanging the aforementioned data with other vehicles 400 through Vehicle-to-Vehicle (V2V) communication.

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as LTE or 5G, WiFi networks, or WAVE networks for communication with the server 200, ITS device 300, and other vehicles 400 (e.g., using 5G-NR sidelink, C-V2X PC 5, or WiFi-6 based links, etc.). In another example, DSRC used in the vehicle 100 may be utilized for inter-vehicle communication. The communication methods among the vehicle 100, the server 200, the ITS device 300, other vehicles 400, and user devices are not limited to the above-described examples.

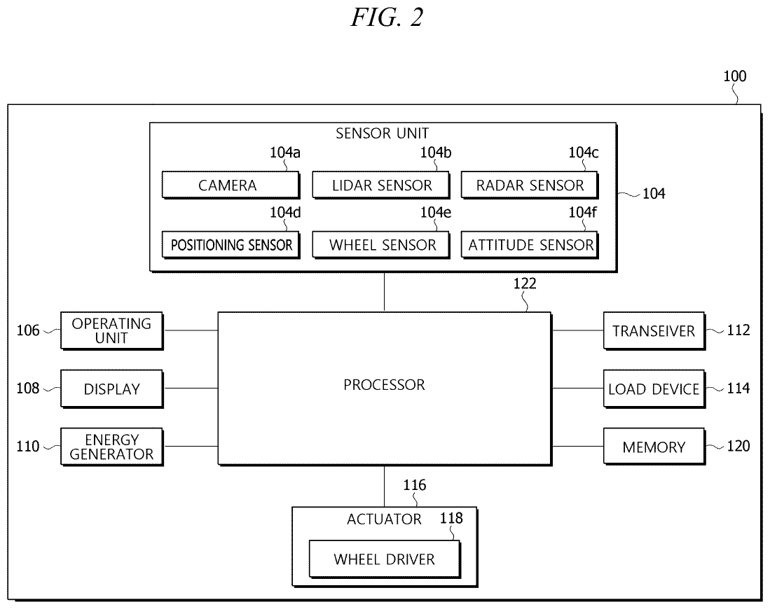

FIG. 2 shows exemplary modules constituting a vehicle according to one example of the present disclosure.

The vehicle 100 may include a sensor unit 102, an operating unit 106, a display 108, a load device 114, and a transceiver 112.

The sensor unit 102 may be equipped with various types of detectors to sense various states and situations occurring in the external environment, internal system, user operations, and passenger space of the vehicle 100 (e.g., cabin-monitoring sensors, temperature sensors, or inertial sensors, etc.). Specifically, the sensor unit 102 may include external-facing cameras 104a, LIDAR sensors 104b, radar sensors 104c, and the like to recognize dynamic and static objects existing outside the vehicle 100 (e.g., vehicles, pedestrians, cyclists, or road obstacles, etc.). The camera 104a may recognize external objects as images during the use of the vehicle 100, generate image data, and transmit the image data to the processor 122. The LIDAR sensor 104b may generate point cloud data as recognized data of external objects to generate three-dimensional spatial information identifying the shape of at least the external objects and transmit the point cloud data to the processor 122. The radar sensor 104c may generate radar data by emitting radio waves of a specific frequency around the vehicle 100 and recognizing the external objects through the reflected radio waves to identify the presence, relative distance, speed, and direction of external objects (e.g., incoming vehicles, crossing pedestrians, or roadside barriers, etc.). Although the present disclosure illustrates including the LIDAR sensor 104b, it may not be included in other examples.

The sensor unit 102 may include positioning sensor 104d, wheel sensor 104e, and attitude sensor 104f to confirm its position, speed, and driving posture. The attitude sensor 104f may include a gyro sensor, angular velocity sensor, accelerometer, and the like (e.g., a 6-axis IMU, multi-range accelerometers, or dual-gyro modules, etc.).

In the present disclosure, the sensor unit 102 includes sensors mainly referenced in the description of the examples but may further include sensors detecting various situations not listed herein (e.g., cabin-monitoring sensors, rain/light sensors, or driver-monitoring sensors, etc.).

The operating unit 106 may be configured as a module for user control for driving. For instance, the operating unit 106 may include a steering wheel for manual driving, an automatic or manual transmission actuator, an accelerator pedal, a brake pedal, a gearbox, and the like (e.g., paddle shifters, drive-mode selectors, or electronic parking brake switches, etc.). The operating unit 106 may further include an interface for the use/deactivation of the autonomous driving mode requested by the user and the selection of detailed function to utilize the autonomous driving function (e.g., lane-change assist, smart cruise control, or self-parking mode, etc.). The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122 (e.g., navigation maps, ADAS alerts, or infotainment content, etc.). The display 108 may also receive driver's requests instructing the processor 122 by being configured as a touch screen detecting driver input.

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100 (e.g., audio systems, power windows, or cabin-comfort modules, etc.).

The transceiver 112 may support mutual communication with the server 200, ITS device 300, and surrounding vehicles 400. The transceiver 112 may include modules handling cellular communication, WAVE, DSRC communication, or other links (e.g., Bluetooth, WiFi, or Ultra-Wideband communication, etc.). For instance, the transceiver 112 may transmit data generated or stored during driving to the server 200 and receive data and software modules transmitted from the server 200. The transceiver 112 may also support communication with electronic devices carried by passengers inside the vehicle 100 (e.g., smartphones, tablets, or wearable devices, etc.). In the present disclosure, the vehicle 100 may transmit and receive data utilized in the methods according to the present disclosure through the transceiver 112.

The vehicle 100 may also include an energy generator 110 and an actuating unit 116.

The energy generator 110 may generate and supply power and electricity used in the driving power system, such as the actuating unit 116, and the non-driving power system. The non-driving power system may include, for example, the sensor unit 102, operating unit 106, display 108, load device 114, transceiver 112, and the like, and may include various components implementing sensing, interface, communication, and convenience functions (e.g., HVAC modules, telematics units, or body-control electronics, etc.), excluding components directly involved in driving operations. When the vehicle 100 is driven based on electric energy, the energy generator 110 may be configured as an electric battery charged from an external source or a combination of an electric battery and a fuel cell charging the battery (e.g., PEM fuel cell, SOFC fuel cell, or reformate-based fuel cell, etc.). In the case of a combination of an electric battery and a fuel cell, the energy generator 110 may include a tank storing a material, such as liquefied hydrogen, used to generate power in the fuel cell (e.g., LH₂ tanks, composite pressure vessels, or cryogenic insulated tanks, etc.). When the vehicle 100 is driven based on fossil energy, the energy generator 110 may be configured as an internal combustion engine. Additionally, when the vehicle 100 is of a hybrid type, the energy generator 110 may be provided as a combination of an internal combustion engine and an electric battery.

The actuator 116 may include at least one module implementing driving operations and may perform at least one of longitudinal control, such as acceleration and deceleration, and lateral control, such as steering, based on user requests from the operating unit 106 (e.g., via throttle actuators, brake-by-wire units, or steer-by-wire systems, etc.). The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118 (e.g., inverter modules, motor controllers, or e-axle units, etc.). When the vehicle 100 is operated based on fossil energy, the actuator 116 may include a transmission gear module delivering the power of the internal combustion engine (e.g., automatic transmissions, CVTs, or dual-clutch transmissions, etc.).

The wheel driver 118 may include a driving force generating module generating driving force for multiple wheels or transferring driving force to the wheels, a braking module decelerating the driving of the wheels, and a steering module realizing lateral control of the wheels. When the vehicle 100 is driven based on electric energy, the driving force generating module may be configured as a motor assembly generating driving force based on the power output from the electric battery (e.g., single-motor, dual-motor, or hub-motor assemblies, etc.). The braking module of the electric-based vehicle 100 may further have a regenerative braking function (e.g., energy recovery during deceleration, blended braking, or battery-charging deceleration modes, etc.).

In addition, the vehicle 100 may include a memory 120 and a processor 122.

The memory 120 may store applications and various data for controlling the vehicle 100, and load applications or read and record data by a request of the processor 122. In the present disclosure, the memory 120 may store an application and at least one instruction for determining a traffic congestion situation for a driving area of the autonomous vehicle 100 and generating congestion control information based on the traffic congestion situation. In addition, the memory 120 may generate final longitudinal control information based on various data including congestion control information and may hold applications and instructions for controlling the vehicle 100 in the traffic congestion situation according to the information (e.g., congestion-aware speed control, stop-and-go behavior, or low-speed cruise strategies, etc.).

The longitudinal control may be control related to a speed, an acceleration, and a relative distance to a surrounding vehicle of the vehicle 100. As one example, the longitudinal control may be motion control in autonomous driving (e.g., adaptive cruise control, stop-and-go control, or smooth deceleration planning, etc.). As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver (e.g., forward-collision warnings, safe-distance feedback, or recommended deceleration prompts, etc.).

Accordingly, as one example, the longitudinal control information may include a speed and an acceleration applied to the vehicle 100. The speed and the acceleration may be generated as longitudinal data that applies to any one of a time range, a distance range, or a specific section along a route. The longitudinal control information may be described as profiles of continuous velocity and acceleration over the range or section. As another example, in addition to the speed and the acceleration, the longitudinal control information may further include control factors applied to the vehicle 100, for example, control according to a relative required distance to surrounding vehicles (e.g., minimum gap settings, safe-following time gaps, or cut-in response adjustments, etc.).

The memory 120 may manage road information, surrounding object information, and vehicle information to generate final longitudinal control information depending on the presence or absence of the traffic congestion situation.

The road information may include lane level route information, road restriction information, a road structure, traffic sign information, and road event information related to the driving lane in which the vehicle 100 moves and surrounding lanes. In the present disclosure, the road on which the vehicle 100 moves may have a plurality of lanes and may specifically include a driving lane on which the vehicle 100 travels and surrounding lanes near the driving lane. The lane level route information may be obtained from lane images or map information acquired from, for example, the camera 104a. The map information is, for example, a lane-level precision map, and may be obtained from an external device such as the server 200 and managed in the memory 120 (e.g., HD maps, lane geometry maps, or road-attribute layers, etc.). The lane level route information may include a trajectory (or route) of each lane, its width, parameters applied to functions related to each lane, and the like. The road restriction information may be a speed limit required on the road on which the vehicle 100 is traveling and a vehicle behavior required to comply with regulations related to the corresponding road. The traffic sign information may be information related to traffic control and guidance displayed on a road surface and signs installed on the road (e.g., yield signs, traffic lights, lane-use arrows, or no-U-turn signs, etc.). The traffic sign information may include, for example, crosswalks, stop lines, U-turns, left turns, speed limits, milestones, and the like.

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road and an elevated road), and the like (e.g., multilane highways, S-curves, roundabouts, or steep-grade sections, etc.). The road event information may be information related to an event on the road. The road event information may include, for example, a construction zone, road event information, and a slow-speed section due to severe weather (e.g., icy patches, heavy-rain zones, or accident-induced slowdowns, etc.).

The surrounding object information may include data related to the behavior of dynamic objects around the vehicle 100. The surrounding object information is behavior data derived by analyzing dynamic objects obtained from at least one of the sensor unit 102, the intelligence transportation system (ITS) device 300, and other vehicles 400 by the processor 122, and the behavior data may be managed in the memory 120. Dynamic objects may be, for example, surrounding vehicles, pedestrians, or other types of mobility, and other types of mobility may be personal mobility such as bicycles or electric scooters (e.g., e-bikes, hoverboards, or delivery robots, etc.). The behavior of the dynamic object may include information related to the position, speed, motion, or the like, of the dynamic object. The speed may include, for example, the speed of each surrounding vehicle and the average speed of surrounding vehicles in a predetermined area. The motion may be defined based on a movement pattern of the dynamic object (e.g., lane-keeping, lane-changing, or stop-and-go patterns, etc.). Taking a vehicle as an example, the motion may be referred to as a driving motion of the vehicle, and the driving motion may be divided into lane keeping driving and biased driving. The lane keeping driving may be a motion in which surrounding vehicles substantially travel along center areas of their own lanes without deviating from the lanes, thereby causing no interference with the driving of the host vehicle traveling in the adjacent lane. The bias driving may be a motion in which a surrounding vehicle does not deviate from its own lane, but travels eccentrically from the center area and approaches the driving lane used by the host vehicle or some of surrounding vehicles deviate from their own lanes and enter the lane of the host vehicle, thereby causing interference with the driving of the host vehicle (e.g., encroaching vehicles, drifting vehicles, or lane-invasion behavior, etc.).

The vehicle information may refer to information related to the vehicle according to an example of the present disclosure. The vehicle information may include data related to a longitudinal state of the vehicle 100, a sensing detection range of the surrounding environment of the sensor unit 102 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104d, the wheel sensor 104e, the attitude sensor 104f, the radar sensor 104c, and the like (e.g., IMU-derived dynamics, wheel-odometer data, or radar-based relative distance, etc.), and managed in the memory 120. The sensing detection range may be a distance and an area detected by the detection performance of the sensor unit 102 that varies depending on the road shape, weather, or the like (e.g., fog, heavy rain, or steep uphill/downhill slopes, etc.). The road shape and weather may be confirmed by road information, surrounding situations detected by the sensor unit 102, and external information provided by the server 200 or the like. Specifically, the detection range of the camera 104a, the lidar sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form (e.g., lookup tables indexed by slope, precipitation, or illumination, etc.).

The data related to autonomous driving control may include a control plan according to various driving situations of the vehicle 100. Here, the driving situation may be, for example, evasive driving, following a preceding vehicle, changing lanes, driving at an intersection, or the like (e.g., merging into traffic, navigating roundabouts, or avoiding roadside obstacles, etc.). In the present disclosure, the data may be described mainly in terms of a control plan (or an action plan) related to control transfer from autonomous driving to manual driving among various driving situations but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification (e.g., pulling over to the shoulder, activating hazard lights, or executing a controlled deceleration, etc.). The transfer-related action plan is not limited to the above-described examples and may be established using various methods and speeds (e.g., gradual slowdown, immediate halt, or controlled lane change, etc.).

The map information stored in the memory 120 may be used to generate a driving route set in the vehicle 100 by the request of the user or the processor 122. In addition, the map information is utilized for autonomous driving and may include a low-precision map or include a high-precision map together with the map (e.g., grid-based maps, HD lane-level maps, or 3D semantic maps, etc.). The map information may be provided to have various information and data included in driving environment information (e.g., road geometry, lane-level rules, or traffic-control metadata, etc.).

The processor 122 may perform overall control of the vehicle 100. The processor 122 may be configured to execute applications and instructions stored in the memory 120.

Hereinafter, a detailed configuration of a processor and a memory for autonomous driving control of a vehicle will be described.

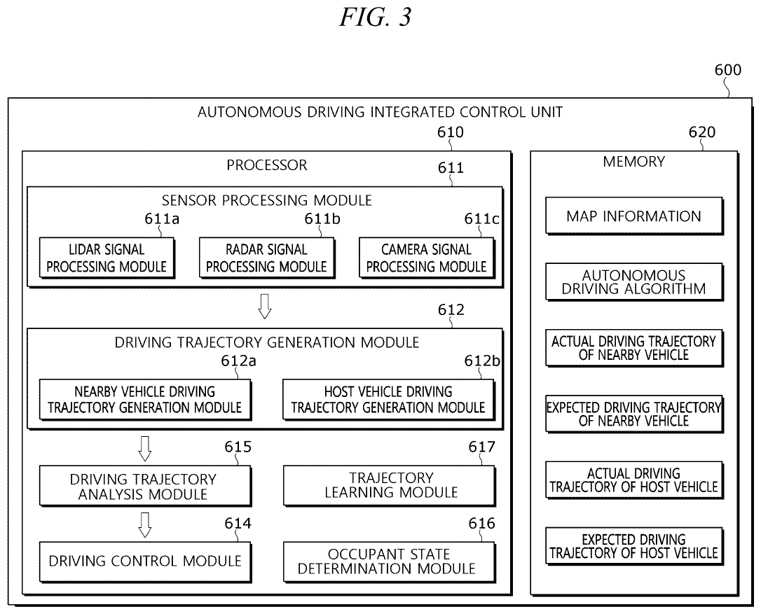

FIG. 3 shows an example of a detailed configuration of a processor and a memory for autonomous driving control in an autonomous driving device according to an example of the present disclosure.

Referring to FIG. 3, a memory 620 may store basic information necessary for autonomous driving control of a vehicle or information generated when autonomous driving of the vehicle is controlled by a processor 610, and the processor 610 may access (read) the information stored in the memory 620 to control the autonomous driving of the vehicle. The memory 620 may be implemented as a computer-readable recording medium and may operate so that the processor 610 may access the memory. Specifically, the memory 620 may be implemented as a hard drive, a magnetic tape, a memory card, a read only memory (ROM), a random access memory (RAM), or an optical data storage device such as a digital video disc (DVD) or an optical disc (e.g., CD-ROM, Blu-ray disc, or solid-state drive emulating optical storage, etc.).

The memory 620 may store map information required for autonomous driving control in the processor 610. The map information stored in the memory 620 may be a navigation map (digital topographic map) that provides information in road units, but may be preferably implemented as a precision road map that provides road information in lane units in order to improve the precision of autonomous driving control, that is, 3D high-precision electronic map data (e.g., LiDAR-based HD maps, centimeter-level lane centerlines, or 3D elevation meshes, etc.). Accordingly, the map information stored in the memory 620 may provide dynamic and static information necessary for the autonomous driving control of the vehicle, such as lanes, lane centerlines, regulatory lines, road boundaries, road centerlines, traffic signs, road surface signs, road shapes and heights, and lane widths (e.g., elevation profiles, curvature annotations, or slope gradients, etc.).

Further, the memory 620 may store an autonomous driving algorithm for the autonomous driving control of the vehicle. The autonomous driving algorithm is an algorithm (recognition, determination, and control algorithm) for recognizing surroundings of the autonomous vehicle, determining a state thereof, and controlling the driving of the vehicle based on a result of the determination, and the processor 610 may execute the autonomous driving algorithm stored in the memory 620 to perform active autonomous driving control in the surrounding environment of the vehicle (e.g., perception fusion, trajectory planning, or motion control routines, etc.).

The processor 610 may control autonomous driving of the vehicle based on driving information and traveling information input from the interface provided through the display 108 described above, information on nearby objects detected through the sensor unit 104, the map information and the autonomous driving algorithm stored in the memory 620. The processor 610 may be implemented as an embedded processor such as a complex instruction set computer (CISC) or a reduced instruction set computer (RISC), or a dedicated semiconductor circuit such as an application specific integrated circuit (ASIC) (e.g., GPU-based modules, neural-network accelerators, or FPGA-based controllers, etc.).

In the present example, the processor 610 may analyze respective driving trajectories of the host vehicle and a nearby vehicle to control autonomous driving of the host vehicle, and to this end, the processor 610 may include a sensor processing module 611, a driving trajectory generation module 612, a driving trajectory analysis module 613, a driving control module 614, a trajectory learning module 615, and an occupant state determination module 616, as illustrated in FIG. 3. Although FIG. 3 illustrates respective modules as independent blocks according to their functions, the modules may be integrated into one module to perform respective functions in an integrated manner (e.g., via shared compute units, unified memory spaces, or multi-threaded execution flows, etc.).

The sensor processing module 611 may determine driving information of the nearby vehicle (that is, which includes a position of the nearby vehicle and may further include a speed and moving direction of the nearby vehicle together with the position) based on a result of detecting a vehicle near the host vehicle through the sensor unit 104. That is, the sensor processing module 611 may determine the position of the nearby vehicle based on a signal received through a lidar sensor 104b, may determine the position of the nearby vehicle based on a signal received through the radar sensor 104c, or may determine the position of the nearby vehicle based on an image captured through the camera 104a. A method of determining the position of the nearby vehicle by utilizing the lidar sensor 104b, the radar sensor 104c, and the camera 104a is a specific example, and an implementation scheme therefor is not limited. Further, the sensor processing module 611 may determine attribute information such as a size and type of the nearby vehicle as well as the position, speed, and moving direction of the nearby vehicle, and an algorithm for determining information such as the position, speed, moving direction, size, and type of the nearby vehicle as described above may be defined in advance (e.g., bounding-box classification, motion prediction heuristics, or vehicle-size clustering, etc.).

The driving trajectory generation module 612 may generate the actual driving trajectory and expected driving trajectory of the nearby vehicle and the actual driving trajectory of the host vehicle, and to this end, the driving trajectory generation module 612 may include a nearby vehicle driving trajectory generation module 612a and a host vehicle driving trajectory generation module 612b, as illustrated in FIG. 3.

First, the nearby vehicle driving trajectory generation module 612a may generate the actual driving trajectory of the nearby vehicle (e.g., using recent motion history, instantaneous velocity vectors, or lane-level constraints, etc.).

Specifically, the nearby vehicle driving trajectory generation module 612a may generate the actual driving trajectory of the nearby vehicle based on the driving information of the nearby vehicle detected by the sensor unit 104 (that is, the position of the nearby vehicle determined by the sensor processing module 611). In this case, in order to generate the actual driving trajectory of the nearby vehicle, the nearby vehicle driving trajectory generation module 612a may refer to the map information stored in the memory 620, and may generate the actual driving trajectory of the nearby vehicle by cross-referencing the position of the nearby vehicle detected by the sensor unit 104 and an arbitrary position in the map information stored in the memory 620 (e.g., lane-center coordinates, waypoint nodes, or landmark positions, etc.). For example, when the nearby vehicle is detected at a specific point by the sensor unit 104, the nearby vehicle driving trajectory generation module 612a may specify the position of the currently detected nearby vehicle in the map information by cross-referencing the position of the detected nearby vehicle and the arbitrary position in the map information stored in the memory 620, and may generate the actual driving trajectory of the nearby vehicle by continuously monitoring the position of the nearby vehicle as described above. That is, the nearby vehicle driving trajectory generation module 612a may generate the actual driving trajectory of the nearby vehicle by mapping the position of the nearby vehicle detected by the sensor unit 104 to a position in the map information stored in the memory 620 based on the cross-reference and accumulating the position (e.g., sequentially appending time-stamped positions, forming polyline segments, or updating a trajectory buffer, etc.).

Meanwhile, the actual driving trajectory of the nearby vehicle may be compared with the expected driving trajectory of the nearby vehicle to be described below and utilized to determine whether the map information stored in the memory 620 is inaccurate. In this case, when an actual driving trajectory of a specific nearby vehicle is compared with an expected driving trajectory, a problem that the map information is incorrectly determined to be inaccurate even though the map information is accurate may occur. For example, when an actual driving trajectory and an expected driving trajectory of a number of nearby vehicles match, but an actual driving trajectory and an expected driving trajectory of any specific nearby vehicle do not match, comparing only the actual driving trajectory of the specific nearby vehicle with the expected driving trajectory may lead to an incorrect determination that the map information is inaccurate even though the map information is accurate. Therefore, it is necessary to determine whether actual driving trajectories of a plurality of nearby vehicles tend to deviate from expected driving trajectories, and to this end, the nearby vehicle driving trajectory generation module 612a may generate respective actual driving trajectories of the plurality of nearby vehicles (e.g., tracking several surrounding vehicles, aggregating deviation results, or applying multi-vehicle consistency checks, etc.).

Further, considering that a driver of the nearby vehicle tends to slightly move a steering wheel left and right during a driving process for driving on a straight path, the actual driving trajectory of the nearby vehicle may be generated in a curved form rather than a straight form, and in order to calculate an error between the actual driving trajectory and an expected driving trajectory to be described later, the nearby vehicle driving trajectory generation module 612a may apply a predetermined smoothing scheme to a raw actual driving trajectory generated in a curved form to generate the actual driving trajectory in a straight shape. Any scheme such as interpolation for each position of the nearby vehicle may be employed as the smoothing scheme (e.g., moving-average filtering, spline interpolation, or least-squares curve fitting, etc.).

Further, the nearby vehicle driving trajectory generation module 612a may generate the expected driving trajectory of the nearby vehicle based on the map information stored in the memory 620.

As described above, the map information stored in the memory 620 may be three-dimensional high-precision electronic map data, and thus the map information may provide dynamic and static information necessary for autonomous driving control of the vehicle, such as lanes, lane centerlines, regulatory lines, road boundaries, road centerlines, traffic signs, road surface signs, road shapes and heights, and lane widths (e.g., curvature profiles, slope gradients, or lane-boundary metadata, etc.). Considering that a vehicle generally drives at a center of a lane, it may be expected that a nearby vehicle near the host vehicle will also travel at the center of the lane, and therefore, the nearby vehicle driving trajectory generation module 612a may generate the expected driving trajectory of the nearby vehicle as a lane centerline reflected in the map information (e.g., selecting the lane's geometric centerline, extracting an HD-map path, or using stored lane polylines, etc.).

The host vehicle driving trajectory generation module 612b may generate the actual driving trajectory along which the host vehicle has driven so far, based on the driving information of the host vehicle acquired through the interface provided through the display 108.

Specifically, the host vehicle driving trajectory generation module 612b may generate the actual driving trajectory of the host vehicle by cross-referencing the position of the host vehicle acquired through the interface provided through the display 108 (that is, the position information of the host vehicle acquired through a GPS receiver 260) and an arbitrary position in the map information stored in the memory 620 (e.g., GPS waypoints, map-feature anchors, or georeferenced road segments, etc.). For example, the current position of the host vehicle may be specified in the map information by cross-referencing the position of the host vehicle acquired through the interface provided through the display 108 and the arbitrary position in the map information stored in the memory 620, and the actual driving trajectory of the host vehicle may be generated by continuously monitoring the position of the host vehicle as described above. That is, the host vehicle driving trajectory generation module 612b may generate the actual driving trajectory of the host vehicle by mapping the position of the host vehicle acquired through the interface provided through the display 108 to the position in the map information stored in the memory 620 based on the cross-reference and accumulating the position.

Further, the host vehicle driving trajectory generation module 612b may generate the expected driving trajectory along which the host vehicle should drive to the destination based on the map information stored in the memory.

That is, the host vehicle driving trajectory generation module 612b may generate the expected driving trajectory to the destination by using the current position of the host vehicle acquired through the interface (that is, current position information of the host vehicle acquired through the GPS receiver 260) and the map information stored in the memory, and the expected driving trajectory of the host vehicle may be generated as a lane center line reflected in the map information stored in the memory 620, like the expected driving trajectories of the nearby vehicle (e.g., selecting optimal lane paths, computing shortest-path options, or generating map-matched trajectory curves, etc.).

The driving trajectories generated by the nearby vehicle driving trajectory generation module 612a and the host vehicle driving trajectory generation module 612b may be stored in the memory 620 and may be utilized for various purposes when the processor 610 controls autonomous driving of the host vehicle (e.g., obstacle prediction, motion planning, or route correction, etc.).

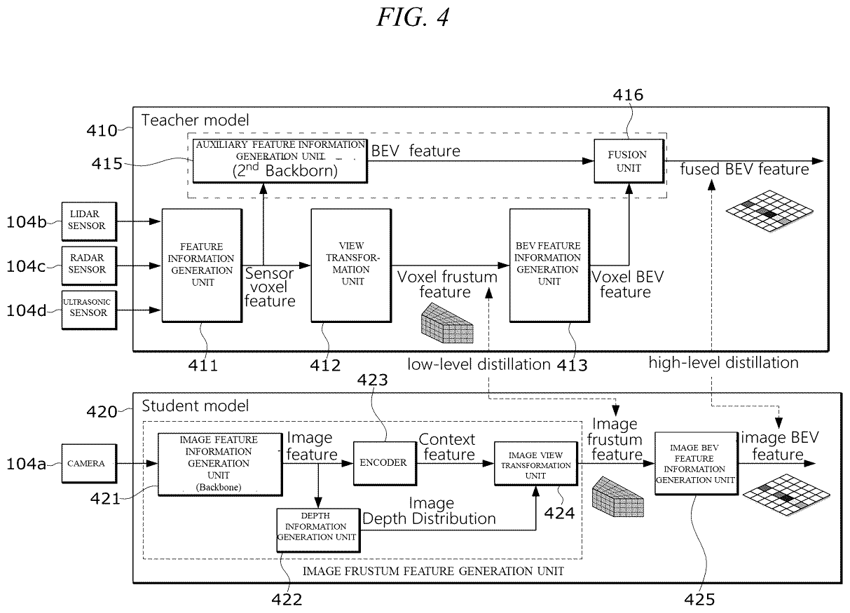

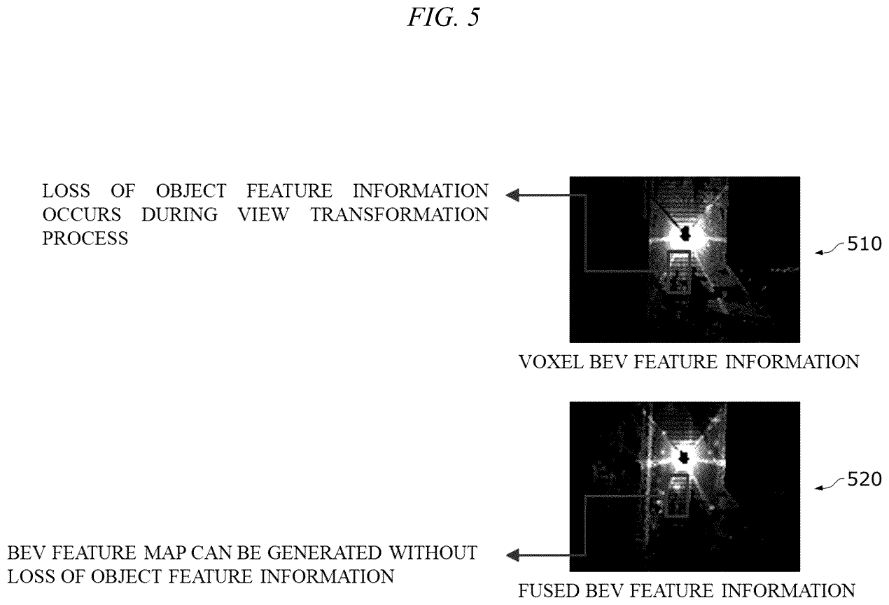

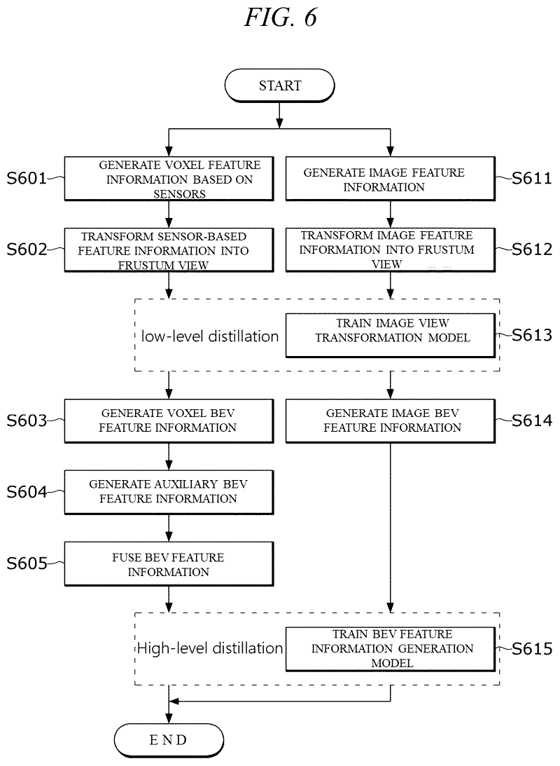

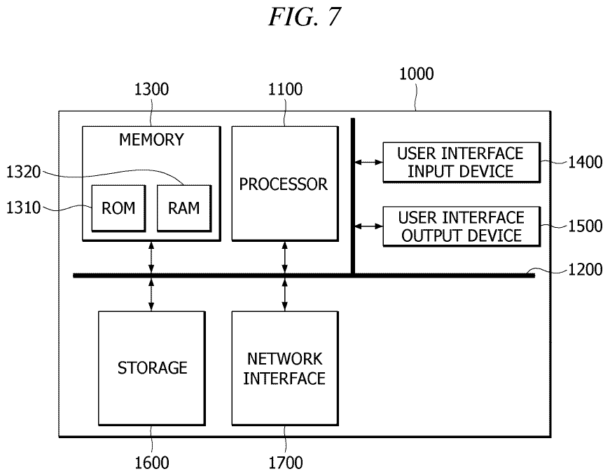

Further, an example of the present disclosure is characterized in that the nearby vehicle driving trajectory generation module 612a tracks a state trajectory of a target object near the host vehicle estimated from a position measurement value obtained by detecting the target object, and a detailed operation of tracking the state trajectory of the target object according to the example of the present disclosure will be described in detail with reference to FIG. 4, FIG. 5, FIG. 6 and FIG. 7 below.

The driving trajectory analysis module 613 may diagnose current reliability of the autonomous driving control for the host vehicle by analyzing respective driving trajectories (that is, the actual driving trajectory and expected driving trajectory of the nearby vehicle, and the actual driving trajectory of the host vehicle) generated by the driving trajectory generation module 612 and stored in the memory 620. The diagnosis of the reliability of the autonomous driving control may be performed by analyzing a trajectory error between the actual driving trajectory and the expected driving trajectory of the nearby vehicle (e.g., lateral deviation, heading-angle drift, or cumulative offset over distance, etc.).

The driving control module 614 may perform a function of controlling autonomous driving of the host vehicle, and specifically, the driving control module 614 may comprehensively use driving information and traveling information input from the interface provided through the display 108 described above, information on nearby objects detected through the sensor unit 104, and the map information stored in the memory 620 to process the autonomous driving algorithm, and transfer control information through the interface provided through the display 108 to cause a low-level control system to control autonomous driving of the host vehicle. Further, when the driving control module 614 controls the autonomous driving as described above in an integrated manner, the driving control module 614 controls the autonomous driving in consideration of the driving trajectories of the host vehicle and the nearby vehicle analyzed by the sensor processing module 611, the driving trajectory generation module 612, and the driving trajectory analysis module 613 described above, thereby improving the precision and stability of the autonomous driving control (e.g., smoother lane keeping, improved cut-in handling, or reduced oscillatory steering, etc.).

The trajectory learning module 615 may perform learning or correction on the actual driving trajectory of the host vehicle generated by the host vehicle driving trajectory generation module 612b. For example, when the trajectory error between the actual driving trajectory and the expected driving trajectory of the nearby vehicle is equal to or greater than a preset threshold value, it may be determined that the map information stored in the memory 620 is inaccurate and the actual driving trajectory of the host vehicle needs to be refined, and accordingly, a lateral shift value for correcting the actual driving trajectory of the host vehicle may be determined so that the driving trajectory of the host vehicle can be refined (e.g., shifting toward lane centerlines, compensating GPS drift, or correcting map-matching errors, etc.).

The occupant state determination module 616 may determine a state and behavior of an occupant based on a state and bio signal of an occupant detected by an internal camera sensor 535 and a biosensor. The occupant state determined by the occupant state determination module 616 may be utilized when the autonomous driving of the host vehicle is performed or a warning is output to the occupant (e.g., drowsiness alerts, distraction warnings, or takeover requests, etc.).

Hereinafter, a detailed operation of a multi-sensor-based knowledge distillation method according to an example of the present disclosure will be described in detail.

FIG. 4 shows exemplary components that process multi-sensor-based knowledge distillation according to an example of the present disclosure.

Referring to FIG. 4, a knowledge distillation processing unit 400 may include a teacher model unit 410 and a student model unit 420.

The teacher model unit 410 is configured to construct the bird's-eye-view (BEV) feature information using the lidar sensor 104b, the radar sensor 104c, and the ultrasonic sensor 104d rather than the camera 104a, and recognize information such as the position, size, and depth of an object from the BEV feature information, and provides the recognized information to the student model unit 420 so that the student model unit 420 is trained to infer information related to the object using only image information input from the camera 104a (e.g., object location, bounding-box dimensions, or depth cues, etc.).

The teacher model unit 410 may include a feature information construction unit 411 that combines the data input from the sensors 104b, 104c, and 104d to construct feature information in voxel units, and a view transformation unit 412 that transforms the feature information in voxel units into a voxel frustum feature according to a coordinate system of the vehicle 100. Further, the teacher model unit 410 may include a BEV feature information construction unit 413 that constructs voxel BEV feature information from the voxel frustum feature.

Further, the view transformation unit 412 may perform voxel sampling for view transformation on the data input from sensors 104b, 104c, and 104d and perform transformation into a frustum view, but during this process, information loss may occur in the sensor data. This information loss may cause performance degradation when knowledge distillation is performed on camera frustum view feature information. Considering this, the teacher model unit 410 may further include an auxiliary feature information generation unit 415 and a fusion unit 416 to compensate for the information lost during the view transformation process. The auxiliary feature information generation unit 415 may additionally include a separate backbone network and may output BEV feature information (BEV feature) through the network (e.g., point-cloud encoders, radar-specific encoders, or ultrasonic-based spatial encoders, etc.). The fusion unit 416 may perform gated fusion on the BEV feature information output from the auxiliary feature information generation unit 415 and the voxel BEV feature information (Voxel BEV feature) output through BEV pooling for view-transformed voxel feature information (Voxel Frustum feature) by the BEV feature information construction unit 413 to finally generate fused BEV feature information (Fused BEV feature) (e.g., weighted fusion, attention-based fusion, or confidence-modulated fusion, etc.).

Referring to FIG. 5, voxel feature information 510 view-transformed through the view transformation unit 412 and fused BEV feature information 520 are illustrated. It can be seen that feature information of some objects is lost when the voxel feature information 510 view-transformed through the view transformation unit 412 is constructed, and it can be seen that the BEV feature information 520 can be constructed without information loss in some objects when the fused BEV feature information 520 is used. Thus, the BEV feature information 520 fused through the auxiliary feature information generation unit 415 and the fusion unit 416 is constructed, making it possible to construct the BEV feature information without information loss and maintain high learning performance through more information (e.g., improved small-object detection, enhanced obstacle geometry, or clearer spatial boundaries, etc.).

An example in which the feature information construction unit 411 constructs sensor voxel feature information, and the view transformation unit 412, the BEV feature information construction unit 413, the auxiliary feature information generation unit 415, and the fusion unit 416 perform respective operations corresponding thereto has been described above in the description of the feature information construction unit 411, the view transformation unit 412, the BEV feature information construction unit 413, the auxiliary feature information generation unit 415, and the fusion unit 416 in the example of the present disclosure. The sensor voxel feature information may include voxel feature information constructed by using the data input from the lidar sensor 104b, the radar sensor 104c, and the ultrasonic sensor 104d, that is, lidar voxel feature information, radar voxel feature information, and ultrasonic voxel feature information, and the view transformation unit 412, the BEV feature information construction unit 413, the auxiliary feature information generation unit 415, and the fusion unit 416 may also perform operations corresponding to the data from the respective sensors (e.g., sensor-specific encoding, resolution-aware pooling, or modality-aligned sampling, etc.).

The student model unit 420 may include an image feature information generation unit 421, a depth information generation unit 422, an encoder 423, an image view transformation unit 424, and an image BEV feature information generation unit 425.

The image feature information generation unit 421 may extract image feature information through a pre-trained backbone network such as ResNet or EfficientNet, and the depth information generation unit 422 may include a deep learning-based depth estimation network (Depth Net) and may predict a depth of an image on a pixel-by-pixel basis and estimate a depth distribution α for each pixel based on the depth of the image (e.g., monocular depth estimation, disparity prediction, or semantic-guided depth inference, etc.). The encoder 423 may extract feature information for a context describing object information in the image. The image view transformation unit 424 transforms a view of the image into a frustum view by reflecting the depth distribution α of the pixel checked by the depth information generation unit 422 to construct view-transformed image feature information (image Frustum feature). For example, the image view transformation unit 424 may include an image view transformation model, the depth distribution α of the pixel and the feature information for the context may be input to the image view transformation model, and the view-transformed image feature information (image Frustum feature) output from the image view transformation model may be checked (e.g., projection into 3D frusta, depth-aware feature lifting, or pixel-to-voxel projection, etc.).

The image BEV feature information generation unit 425 may construct the image BEV feature information using the view-transformed image feature information. For example, the image BEV feature information generation unit 425 may include a BEV feature information generation model, and the view-transformed image feature information may be input to the BEV feature information generation model, and output data of the BEV feature information generation model may be used to construct the image BEV feature information (e.g., BEV pooling, planar-splatting operations, or height-collapsing mechanisms, etc.).

Further, the teacher model unit 410 may provide the view-transformed voxel feature information (Voxel Frustum feature) to the student model unit 420, and train the image view transformation model so that the image view transformation unit 424 of the student model unit 420 can generate the view-transformed image feature information (image Frustum feature) with a minimized modality gap with the view-transformed voxel feature information (Voxel Frustum feature) (e.g., minimizing feature-distance metrics, alignment losses, or cross-modal consistency errors, etc.).

Further, the teacher model unit 410 may provide the fused BEV feature information (Fused BEV feature) to the student model unit 420, and train the BEV feature information generation model so that the image BEV feature information generation unit 425 of the student model unit 420 can generate the image BEV feature information with a minimized or reduced modality gap with the fused BEV feature information (Fused BEV feature) (e.g., using BEV-supervision losses, feature-correlation losses, or distillation-based matching losses, etc.).

The student model unit 420 trained through the above-described operation may independently perform inference after the training is completed. For example, even when the student model unit 420 receives only an image input from the camera 104a, the student model unit 420 may generate the view-transformed image feature information (image Frustum feature) at a level that may reflect information of the object detected through the sensor, through the image view transformation unit 424 trained to minimize a modality gap with the view-transformed voxel feature information (Voxel Frustum feature), and may detect information of the object at a level close to information (information on the position, size, depth, etc.) of the object detected by the lidar sensor 104b, the radar sensor 104c, and the ultrasonic sensor 104d, through the image BEV feature information generation unit 425 trained to minimize the modality gap with the fused BEV feature information (Fused BEV feature) (e.g., detecting vehicle bounding boxes, estimating pedestrian depth, or identifying roadside obstacles, etc.).

FIG. 6 shows an exemplary operation of the multi-sensor-based knowledge distillation method according to the example of the present disclosure.

The multi-sensor-based knowledge distillation method according to the example of the present disclosure may be performed by the processor of the vehicle described above.

Referring to FIG. 6, the processor 610 may combine the data input from the lidar sensor 104b, the radar sensor 104c, and the ultrasonic sensor 104d rather than the camera 104a to construct the feature information in voxel units (S601) (e.g., voxelizing point clouds, binning radar returns, or discretizing ultrasonic measurements, etc.).

The processor 610 may transform the feature information in voxel units into the voxel frustum feature according to the coordinate system of the vehicle 100(S602 ), and construct voxel BEV feature information from the voxel frustum feature (S603).

Further, the processor 610 may perform voxel sampling for view transformation on the data input from sensors 104b, 104c, and 104d and perform transformation into a frustum view, but during this process, information loss may occur in the sensor data. This information loss may cause performance degradation when knowledge distillation is performed on camera frustum view feature information. Considering this, the processor 610 may additionally include a separate backbone network and may output BEV feature information (BEV feature) through the network (S604) (e.g., using a LiDAR encoder, radar backbone, or multi-layer voxel encoder, etc.). The processor 610 may perform gated fusion on the BEV feature information and the voxel BEV feature information (Voxel BEV feature) output through BEV pooling for view-transformed voxel feature information (Voxel Frustum feature) to generate the fused BEV feature information (Fused BEV feature) (S605) (e.g., via attention-based fusion, weighted gating, or learned confidence fusion, etc.).

Further, the view-transformed voxel feature information (Voxel Frustum feature) generated in operation S602, and the fused BEV feature information (Fused BEV feature) generated in operation S605 may be used as data of the teacher model during knowledge distillation.

Meanwhile, the processor 610 extracts the image feature information from image data input from the camera 104a through a pre-trained backbone network such as ResNet or EfficientNet (S611) (e.g., ResNet-50, EfficientNet-B3, or MobileNet variants, etc.).

Next, the processor 610 may include a deep learning-based depth estimation network (Depth Net) and may predict a depth of an image on a pixel-by-pixel basis and estimate a depth distribution α for each pixel based on the depth of the image, and extract feature information for a context describing object information in the image. The processor 610 transforms a view of the image into a frustum view by reflecting the depth distribution α of the pixel and constructs the view-transformed image feature information (image Frustum feature) (S612). Here, the view-transformed image feature information may be generated through the image view transformation model (e.g., pixel lifting, frustum projection, or depth-guided feature lifting, etc.).

The processor 610 may perform learning of the image view transformation model so that the view-transformed image feature information (image Frustum feature) with a minimized modality gap with the view-transformed voxel feature information (Voxel Frustum feature) can be generated by using the view-transformed voxel feature information (voxel frustum feature) generated in operation S602 (S613) (e.g., minimizing feature-distance losses, matching spatial distributions, or applying cross-modal distillation, etc.).

Thereafter, the processor 610 may input the view-transformed image feature information to the BEV feature information generation model, and use the output data of the BEV feature information generation model to construct the image BEV feature information (S614) (e.g., BEV pooling, 2D-to-BEV collapsing, or height-axis aggregation, etc.).

The processor 610 may perform learning of the BEV feature information generation model so that the image BEV feature information minimizes the modality gap with the fused BEV feature information (Fused BEV feature) (S615) (e.g., distillation via BEV-level regression, cross-feature alignment, or BEV-channel supervision, etc.). FIG. 7 shows an example computing system (e.g., a computing device of a vehicle or any other apparatus). One or more controllers, processors, etc. described herein, such as one or more components of the vehicle 100 (e.g., DCCU), one or more components of the server 200, one or more components of other vehicle 400, and any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with examples disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In accordance with an aspect of the present disclosure, there is provided a multi-sensor-based knowledge distillation learning method, comprising: determining a sensor data received from a plurality of sensors, and generating at least one piece of sensor data-based voxel feature information using the sensor data; performing view transformation on the at least one piece of sensor data-based voxel feature information to construct a view-transformed feature information, and generating a first voxel bird's-eye-view (BEV) feature information using the view-transformed feature information; generating a second voxel BEV feature information using the at least one piece of sensor data-based voxel feature information; generating the first voxel BEV feature information and the second voxel BEV feature information to construct fused voxel BEV feature information; performing learning of an image view transformation model that performs view transformation on the image feature information based on image data input from a camera using the view-transformed feature information; and performing learning of an image BEV generation model that generates image BEV feature information corresponding to the view-transformed image feature information by using the fused voxel BEV feature information.

The generating of the first voxel BEV feature information using the view-transformed feature information may include performing view transformation on the at least one piece of sensor data-based voxel feature information by using a view transformation model that performs view transformation on the at least one piece of sensor data-based voxel feature information. The view transformation model may be a model trained to perform view transformation according to the same coordinate system as a coordinate system in which the image feature information is view-transformed.

The generating of the at least one piece of sensor data-based voxel feature information may include inputting the sensor data to a backbone network that generates voxel feature information, and checking the voxel feature information output from the backbone network to generate the at least one piece of sensor data-based voxel feature information.

In accordance with another aspect of the present disclosure, there is provided a method for inferring image bird's-eye-view (BEV) feature information, the method comprises preparing an image view transformation model trained to perform view transformation on image feature information based on image data for learning using view-transformed feature information, and an image BEV generation model trained to generate the image BEV feature information corresponding to the view-transformed image feature information by using the fused voxel BEV feature information, by using a teacher model that generates sensor data received from a plurality of sensors, at least one piece of sensor data-based voxel feature information generated using the sensor data, the view-transformed feature information constructed by performing view transformation on the at least one piece of sensor data-based voxel feature information, a first voxel BEV feature information constructed using the view-transformed feature information, a second voxel BEV feature information constructed using the at least one piece of sensor data-based voxel feature information, and fused voxel BEV feature information constructed by concatenating the first voxel BEV feature information and the second voxel BEV feature information; inputting an image feature information for inference corresponding to image data for inference to the image view transformation model and inferring the view-transformed image feature information output through the image view transformation model; and inputting the view-transformed image feature information to the image BEV generation model and inferring the image BEV feature information output from the image BEV generation model.

In accordance with another aspect of the present disclosure, there is provided a multi-sensor-based knowledge distillation learning device, the device comprises a plurality of sensors including at least one of a camera, a LIDAR sensor, a radar sensor, and an ultrasonic sensor; a memory configured to store a multi-sensor-based knowledge distillation learning program; and a processor configured to execute a multi-sensor-based knowledge distillation learning program stored in the memory to determine a sensor data received from the plurality of multi-sensors and generate at least one piece of sensor data-based voxel feature information using the sensor data; perform view transformation on the at least one piece of sensor data-based voxel feature information to construct a view-transformed feature information and generate a first voxel bird's-eye-view (BEV) feature information using the view-transformed feature information; generate a second voxel BEV feature information using the at least one piece of sensor data-based voxel feature information; generate a fused voxel BEV feature information by concatenating the first voxel BEV feature information and the second voxel BEV feature information; perform learning of an image view transformation model that performs view transformation on the image feature information based on image data input from the camera using the view-transformed feature information; and perform learning of an image BEV generation model that generates the image BEV feature information corresponding to the view-transformed image feature information by using the fused voxel BEV feature information.

The processor may perform view transformation on the at least one piece of sensor data-based voxel feature information by using a view transformation model that performs view transformation on the at least one piece of sensor data-based voxel feature information. The view transformation model may be a model trained to perform view transformation according to the same coordinate system as a coordinate system in which the image feature information is view-transformed.

The processor may input the sensor data to a backbone network that generates voxel feature information and checks the voxel feature information output from the backbone network to generate the at least one piece of sensor data-based voxel feature information.

In accordance with another aspect of the present disclosure, there is provided a multi-sensor-based knowledge distillation learning device, the device comprises a plurality of sensors including at least one of a camera, a LIDAR sensor, a radar sensor, and an ultrasonic sensor; a memory configured to store an image bird's-eye-view (BEV) feature information inference program; and a processor configured to execute the image BEV feature information inference program stored in the memory to prepare an image view transformation model trained to perform view transformation on image feature information based on image data for learning using view-transformed feature information, and an image BEV generation model trained to generate the image BEV feature information corresponding to the view-transformed image feature information by using the fused voxel BEV feature information, by using a teacher model that generates sensor data received from the plurality of multi-sensors, at least one piece of sensor data-based voxel feature information generated using the sensor data, the view-transformed feature information constructed by performing view transformation on the at least one piece of sensor data-based voxel feature information, a first voxel BEV feature information constructed using the view-transformed feature information, a second voxel BEV feature information constructed using the at least one piece of sensor data-based voxel feature information, and fused voxel BEV feature information constructed by concatenating the first voxel BEV feature information and the second voxel BEV feature information; input an image feature information for inference corresponding to image data for inference to the image view transformation model and infer the view-transformed image feature information output through the image view transformation model; and input the view-transformed image feature information to the image BEV generation model and infer the image BEV feature information output from the image BEV generation model.

In accordance with another aspect of the present disclosure, there is provided a non-transitory computer-readable storage medium including computer executable instructions, wherein the instructions, when executed by a processor, cause the processor to perform a multi-sensor-based knowledge distillation learning method, the method comprise: determining a sensor data received from a plurality of sensors, and generating at least one piece of sensor data-based voxel feature information using the sensor data; performing view transformation on the at least one piece of sensor data-based voxel feature information to construct a view-transformed feature information, and generating a first voxel bird's-eye-view (BEV) feature information using the view-transformed feature information; generating a second voxel BEV feature information using the at least one piece of sensor data-based voxel feature information; generating the first voxel BEV feature information and the second voxel BEV feature information to construct fused voxel BEV feature information; performing learning of an image view transformation model that performs view transformation on the image feature information based on image data input from a camera using the view-transformed feature information; and performing learning of an image BEV generation model that generates image BEV feature information corresponding to the view-transformed image feature information by using the fused voxel BEV feature information.

According to the disclosed disclosure, it is possible to utilize complementary characteristics between heterogeneous sensors by using data detected from an ultrasonic sensor, a radar sensor, a lidar sensor, etc., to train a camera object recognition network, and to improve the accuracy of a recognition system.

Further, according to the disclosed disclosure, it is possible to train a camera object recognition network in real time through knowledge distillation that utilizes ultrasonic, radar, and lidar sensor data for learning in the camera object recognition network, and to improve the accuracy of a recognition system by using the camera object recognition network.

According to the disclosed disclosure, it is possible to utilize complementary characteristics between heterogeneous sensors by using data detected from an ultrasonic sensor, a radar sensor, a lidar sensor, etc., to train a camera object recognition network, and to improve the accuracy of a recognition system.

Further, according to the disclosed disclosure, it is possible to train a camera object recognition network in real time through knowledge distillation that utilizes ultrasonic, radar, and lidar sensor data for learning in the camera object recognition network, and to improve the accuracy of a recognition system by using the camera object recognition network.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative examples, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the examples disclosed in the present disclosure are intended to explain, not to limit, the technical scope of the present disclosure, and the technical scope of the present disclosure is not limited by the examples. The protection scope of the present disclosure should be interpreted based on the following claims and it should be appreciated that all technical scopes included within a range equivalent thereto are included in the protection scope of the present disclosure.

What is claimed is:

1. A method performed by an apparatus for a vehicle, the method comprising:
obtaining, via a plurality of sensors of the vehicle, sensor data;
generating, based on the sensor data, at least one piece of sensor data-based voxel feature information;
performing a view transformation on the at least one piece of sensor data-based voxel feature information to construct sensor data-based view-transformed feature information;
generating, based on the sensor data-based view-transformed feature information, first voxel bird's-eye-view (BEV) feature information;
generating, based on the at least one piece of sensor data-based voxel feature information, second voxel BEV feature information;
generating, based on the first voxel BEV feature information and the second voxel BEV feature information, fused voxel BEV feature information;
determining, based on image data obtained via a camera of the vehicle, image feature information;
training, based on the sensor data-based view-transformed feature information and the image feature information, an image view transformation model, wherein the image view transformation model is trained to perform view transformation on the image feature information to generate view-transformed image feature information;
training, based on the fused voxel BEV feature information, an image BEV generation model, wherein the image BEV generation model is trained to generate image BEV feature information corresponding to the view-transformed image feature information;
transmitting, to the vehicle, a signal indicating the image BEV feature information; and
causing, based on the transmitting of the signal, a control operation of the vehicle.

2. The method of claim 1,
wherein the performing of the view transformation comprises performing the view transformation using a view transformation model, and
wherein the view transformation model is a model trained to perform the view transformation based on a coordinate system in which the image feature information is view-transformed.

3. The method of claim 1, wherein the generating of the at least one piece of sensor data-based voxel feature information comprises:
inputting the sensor data to a backbone network that outputs voxel feature information, and
based on the voxel feature information output from the backbone network, generating the at least one piece of sensor data-based voxel feature information.

4. The method of claim 1, further comprising
generating, based on a teacher model and based on the sensor data,
the at least one piece of sensor data-based voxel feature information,
the sensor data-based view-transformed feature information,
the first voxel BEV feature information,
the second voxel BEV feature information, and
the fused voxel BEV feature information, wherein the fused voxel BEV feature information is constructed by concatenating the first voxel BEV feature information and the second voxel BEV feature information.

5. The method of claim 1, further comprising:
inputting the image feature information to the trained image view transformation model and outputting the view-transformed image feature information from the trained image view transformation model; and
inputting the view-transformed image feature information to the trained image BEV generation model and outputting the image BEV feature information from the trained image BEV generation model.

6. The method of claim 1, wherein the generating of the at least one piece of sensor data-based feature voxel information is based on a part of the sensor data, and wherein the part is obtained via at least one of:
a light detection and ranging (LIDAR) sensor of the vehicle,
a radar sensor of the vehicle, or
an ultrasonic sensor of the vehicle.

7. The method of claim 1, wherein the training of the image BEV generation model comprises adjusting parameters of the image BEV generation model to cause the image BEV feature information to match the fused voxel BEV feature information.

8. An apparatus for a vehicle, the apparatus comprising:
a plurality of sensors comprising at least one of a camera, a light detection and ranging (LIDAR) sensor, a radar sensor, or an ultrasonic sensor;
a processor; and
a memory storing at least one instruction that, when executed by the processor, is configured to cause the apparatus to:
obtain, via the plurality of sensors, sensor data,
generate, based on the sensor data, at least one piece of sensor data-based voxel feature information,
perform a view transformation on the at least one piece of sensor data-based voxel feature information to construct sensor data-based view-transformed feature information,
generate, based on the sensor data-based view-transformed feature information, first voxel bird's-eye-view (BEV) feature information,
generate, based on the at least one piece of sensor data-based voxel feature information, second voxel BEV feature information,
generate, based on the first voxel BEV feature information and the second voxel BEV feature information, a fused voxel BEV feature information,
determine, based on image data obtained via the camera, image feature information,
train, based on the sensor data-based view-transformed feature information and the image feature information, an image view transformation model, wherein the image view transformation model is trained to perform a view transformation on the image feature information to generate view-transformed image feature information,
train, based on the fused voxel BEV feature information, an image BEV generation model, wherein the image BEV generation model is trained to generate image BEV feature information corresponding to the view-transformed image feature information,
transmit, to the vehicle, a signal indicating the image BEV feature information, and
cause, based on the transmission of the signal, a control operation of the vehicle.

9. The apparatus of claim 8,
wherein the at least one instruction, when executed by the processor, is configured to cause the apparatus to use a view transformation model to perform the view transformation on the at least one piece of sensor data-based voxel feature information, and
wherein the view transformation model is a model trained to perform the view transformation based on a coordinate system in which the image feature information is view-transformed.

10. The apparatus of claim 8, wherein the at least one instruction, when executed by the processor, is configured to cause the apparatus to:
input the sensor data to a backbone network that outputs voxel feature information, and
based on the voxel feature information output from the backbone network, generate the at least one piece of sensor data-based voxel feature information.

11. The apparatus of claim 8, wherein the at least one instruction, when executed by the processor, is configured to cause the apparatus to generate,
based on a teacher model and based on the sensor data,
the at least one piece of sensor data-based voxel feature information,
the sensor data-based view-transformed feature information,
the first voxel BEV feature information,
the second voxel BEV feature information, and
the fused voxel BEV feature information, wherein the fused voxel BEV feature information is constructed by concatenating the first voxel BEV feature information and the second voxel BEV feature information.

12. The apparatus of claim 8, wherein the at least one instruction, when executed by the processor, is configured to cause the apparatus to:
input the image feature information to the trained image view transformation model and output the view-transformed image feature information from the trained image view transformation model, and
input the view-transformed image feature information to the trained image BEV generation model and output the image BEV feature information from the trained image BEV generation model.

13. The apparatus of claim 8, wherein the at least one instruction, when executed by the processor, is configured to cause the apparatus to generate the at least one piece of sensor data-based voxel feature information based on a part of the sensor data, wherein the part is obtained via at least one of the LIDAR sensor, the radar sensor, or the ultrasonic sensor.

14. The apparatus of claim 8, wherein the at least one instruction, when executed by the processor, is configured to cause the apparatus to train the image BEV generation model by adjusting parameters of the image BEV generation model to cause the image BEV feature information to match the fused voxel BEV feature information.

15. A non-transitory computer-readable medium storing instructions that, when executed, cause an apparatus for a vehicle to:
obtain, via a plurality of sensors of the vehicle, sensor data generate, based on the sensor data, at least one piece of sensor data-based voxel feature information,
perform a view transformation on the at least one piece of sensor data-based voxel feature information to construct sensor data-based view-transformed feature information,
generate, based on the sensor data-based view-transformed feature information, first voxel bird's-eye-view (BEV) feature information,
generate, based on the at least one piece of sensor data-based voxel feature information, second voxel BEV feature information,
generate, based on the first voxel BEV feature information and the second voxel BEV feature information, fused voxel BEV feature information,
determine, based on image data obtained via a camera of the vehicle, image feature information
train, based on the fused voxel BEV feature information and image feature information, an image view transformation model, wherein the image view transformation model is trained to perform view transformation on the image feature information to generate view-transformed image feature information,
train, based on the fused voxel BEV feature information, an image BEV generation model, wherein the image BEV generation model is trained to generate image BEV feature information corresponding to the view-transformed image feature information,
transmit, to the vehicle, a signal indicating the image BEV feature information; and
cause, based on the transmission of the signal, autonomous driving control of the vehicle.

16. The non-transitory computer-readable medium of claim 15, wherein the instructions, when executed, further cause the apparatus to perform the view transformation by using a view transformation model, and
wherein the view transformation model is a model trained to perform the view transformation based on a coordinate system in which the image feature information is view-transformed.

17. The non-transitory computer-readable medium of claim 15,
wherein the instructions, when executed, further cause the apparatus to:
input the sensor data to a backbone network that outputs voxel feature information, and
based on the voxel feature information output from the backbone network, generate the at least one piece of sensor data-based voxel feature information.

18. The non-transitory computer-readable medium of claim 15, wherein the instructions, when executed, further cause the apparatus to generate, based on a teacher model and based on the sensor data,
the at least one piece of sensor data-based voxel feature information,
the sensor data-based view-transformed feature information,
the first voxel BEV feature information,
the second voxel BEV feature information, and
the fused voxel BEV feature information, wherein the fused voxel BEV feature information is constructed by concatenating the first voxel BEV feature information and the second voxel BEV feature information.

19. The non-transitory computer-readable medium of claim 15, wherein the instructions, when executed, further cause the apparatus to:
input the image feature information to the trained image view transformation model and output the view-transformed image feature information from the trained image view transformation model, and
input the view-transformed image feature information to the trained image BEV generation model and output the image BEV feature information from the trained image BEV generation model.

20. The non-transitory computer-readable medium of claim 15, wherein the instructions, when executed, further cause the apparatus to generate, based on a part of the sensor data, the at least one piece of sensor data-based voxel feature information, and wherein the part is obtained via at least one of:
a light detection and ranging (LIDAR) sensor of the vehicle,
a radar sensor of the vehicle, or
an ultrasonic sensor of the vehicle.
